(19) United States
(12) Patent Application Publication
(10) Pub. No.: US 2015/0128049 A1
(43) Pub. Date: May 7, 2015

(54) ADVANCED USER INTERFACE

(71) Applicants: Robert S. BLOCK, Reno, NV (US); Alexander A. WENGER, Melville, NY (US); Paul SIDLO, Santa Monica, CA (US)

(72) Inventors: Robert S. Block, Reno, NV (US); Alexander A. Wenger, Melville, NY (US); Paul Sidlo, Santa Monica, CA (US)

(21) Appl. No.: 14/413,057

(22) PCT Filed: Jul. 8, 2013
(86) PCT No.: PCT/US2013/049552

§ 371 Date: Jan. 6, 2015

Related U.S. Application Data
(60) Provisional application No. 61/668,933, filed on Jul. 6, 2012.
(60) Provisional application No. 61/801,802, filed on Mar. 15, 2013.

(51) Int. Cl. G06F 3/0488; G06F 3/0485; G06F 3/16; G06F 3/0481; G06F 3/0482

(52) U.S. Cl. CPC G06F 3/04886; G06F 3/04817; G06F 3/0482; G06F 3/167; G06F 3/0485
USPC 715/728; 715/773

(57) ABSTRACT

An advanced user interface includes a display device and a processing unit. The processing unit causes the display device to display a dynamic user interface containing a plurality of input areas in an adaptive graphical arrangement, detect user in puts on the dynamic user interface, and record the user inputs in a memory unit in association with a context of information inputted by the user. The graphical arrangement of input areas includes at least one primary input area, each of which is respectively associated with different information. The processing unit detects a user input for one of the input areas, compares the detected user input with prior user inputs recorded in the memory unit, and predicts a first next user input based on the comparison and the context of information associated with the detected user input. Based on the predicted first next user input, the processing unit dynamically modifies the displayed arrangement of the input areas so that information associated with the predicted first next user input is characterized and displayed as the at least one primary input area on the dynamic user interface.

### RELATED APPLICATIONS

The present application claims priority to U.S. Provisional Application No. 61/668,933, filed on Jul. 6, 2012, and U.S. Provisional Application No. 61/801,802, filed on Mar. 15, 2013.

### FIELD

The present disclosure relates to an advanced user interface (AUI) which is configured to be dynamically updated based on user operations.

### SUMMARY

An exemplary embodiment of the present disclosure provides an apparatus which includes at least one display device, and a processing unit configured to cause the at least one display device to display a dynamic user interface containing a plurality of input areas in an adaptive graphical arrangement, detect user inputs on the dynamic user interface, and record the user inputs in a memory unit in association with a context of information inputted by the user. The graphical arrangement of input areas includes at least one primary input area, each of the input areas being respectively associated with different information. The processing unit is configured to detect a user input for one of the input areas, compare the detected user input with prior user inputs recorded in the memory unit, and predict a first next user input based on the comparison and the context of information associated with the detected user input. The processing unit is configured to, based on the predicted first next user input, dynamically modify the displayed arrangement of the input areas so that information associated with the predicted first next user input is characterized and displayed as the at least one primary input area on the dynamic user interface.

In accordance with an exemplary embodiment, when the processing unit predicts the first next user input based on the comparison and the context of information associated with the detected user input, the processing unit is configured to predict a respective likelihood of other information being selected in a second next user input based on the context of information associated with the first next user input. In addition, the processing unit is configured display the other information associated with the context of information associated with the predicted first next user input in logical association with the primary key based on the respective likelihood of the other information being selected in the second next user input.

In accordance with an exemplary embodiment, the primary input area is arranged in logical association with at least one secondary input area. The processing unit is configured display the other information associated with the context of information associated with the predicted first next user input in the secondary input area based on the respective likelihood of the other information being selected in the second next user input.

In accordance with an exemplary embodiment, the primary input area and the at least one secondary input area are each arranged as a geometric shape.

In accordance with an exemplary embodiment, at least one tertiary input area is arranged in logical association with the at least one secondary input area.

In accordance with an exemplary embodiment, the input areas are associated with information including at least one of alphabet letters, numbers, symbols, phrases, sentences, paragraphs, forms, icons representing an executable operation, icons representing a commodity, icons representing a location, icons representing a form of communication, a command, and a mathematical notation.

In accordance with an exemplary embodiment, the dynamic user interface includes a prediction field. The processing unit is configured to predict information associated with one or more user inputs and display the predicted information in the prediction field for the user to one of accept and reject the predicted information.

In accordance with an exemplary embodiment, the processing unit is configured to compare a detected user input to the dynamic user interface with the predicted first next user input, and determine whether the user selected an incorrect input area based on the predicted first next user input. When the processing unit determines that the user selected an incorrect input area, the processing unit is configured to output a proposed correction in the prediction field for the user to one of accept and reject the proposed correction.

In accordance with an exemplary embodiment, the apparatus is integrated in a mobility assistance device as an input/output unit for the mobility assistance device.

In accordance with an exemplary embodiment, the mobility assistance device includes at least one of a personal transport vehicle, a walking assistance device, an automobile, an aerial vehicle, and a nautical vehicle.

In accordance with an exemplary embodiment, the processing unit is configured to control the display device to display navigation information to a destination that is at least one of input and selected by the user by selecting at least one of the input areas of the dynamic user interface.

In accordance with an exemplary embodiment, the apparatus is a computing device including at least one of a notebook computer, a tablet computer, a desktop computer, and a smartphone.

In accordance with an exemplary embodiment, the computing device includes two display devices. The processing unit is configured to display the dynamic user interface on one of the two display devices, and display information associated with at least one of the input areas selected by the user on the other one of the two display devices.

In accordance with an exemplary embodiment, the processing unit is configured to control the display device to display the dynamic user interface on a first part of the display device, and display information associated with at least one of the input areas selected by the user on a second part of the display device such that the dynamic user interface and the information associated with the at least one of the input areas selected by the user are displayed together on the display device.

In accordance with an exemplary embodiment, the apparatus includes at least one of an audio input unit configured to receive an audible input from the user, a visual input unit configured to receive a visual input from the user, and a tactile unit configured to receive a touch input from the user. The processing unit is configured to interpret at least one of an audible input, a visual input, and a tactile input received from the user as a command to at least one of (i) select a particular input area on the dynamic user interface, (ii) scroll through input areas on the dynamic user interface, (iii) request information respectively associated with one or more user input areas on the dynamic user interface, and (iv) control movement of a mobility assistance device in which the apparatus is integrated.

In accordance with an exemplary embodiment, the visual input unit is configured to obtain a facial image of at least one of the user and another individual. The processing unit is configured to associate personal information about the at least one of the user and the other individual from whom the facial image was obtained, and control the display unit to display the associated personal information.

In accordance with an exemplary embodiment, the processing unit is configured to generate an icon for display on one of the input areas of the dynamic user interface based on a successive selection of a combination of input areas by the user.

In accordance with an exemplary embodiment, the processing unit is configured to recognize repeated user inputs on the dynamic user interface based on the recorded user inputs in the memory unit, and generate an icon for display on one of the input areas of the dynamic user interface for an activity associated with the repeated user inputs.

In accordance with an exemplary embodiment, the processing unit is configured to at least one of customize the dynamic user interface and a mouse associated with the dynamic user interface based on an activity of the user.

In accordance with an exemplary embodiment, the processing unit is configured to transfer information associated with one or more user inputs between different applications executable on the apparatus.

In accordance with an exemplary embodiment, the processing unit is configured to control the display device to prompt the user to perform an activity in association with information recorded in the memory unit with respect to at least one of a date, time and event.

### BRIEF DESCRIPTION OF THE DRAWINGS

Additional refinements, advantages and features of the present disclosure are described in more detail below with reference to exemplary embodiments illustrated in the drawings, in which:

FIG. 1 is an example of an advanced user interface (AUI) according to an exemplary embodiment;

FIG. 2 is an example of the AUI according to an exemplary embodiment;

FIG. 3 illustrates an example of the AUI in which events, relationships, people, dates and other information can be remembered, organized and displayed to the user to support quick communication access;

FIG. 4 illustrates an example of the AUI implemented in a dual-touch tablet;

FIG. 5 illustrates an example of the AUI implemented in a portable computing device;

FIG. 6 illustrates an example of the AUI implemented in a smartphone in which the AUI enables a user to customize the size of the input and output areas of the AUI;

FIG. 7 illustrates an example of attribute grouping for showing relationships based on attributes;

FIG. 8 illustrates an example of a daily schedule for an individual which identifies, in an customizable format, areas of interest associated with particular people, tasks, activities, attributes, time and context information, etc.; and

FIG. 9 illustrates an example of attribute grouping based on an individual or group's interests or any other type of association.

### DETAILED DESCRIPTION

The present disclosure provides an advanced, dynamic user interface (AUI) which is dynamically updated based on user operations. The AUI responds to user input by simplifying the sourcing and displaying of related information. The dynamic user interface of the AUI uses an adaptive (e.g., modifiable) graphical arrangement of information. It is based on a self-organizing intelligent feedback system that supports a minimum information input for maximum information output through linked attributes. The predictive delivery of information is based on the context and the user interaction. These operative features of the AUI will be described in more detail below with reference to exemplary embodiments of the present disclosure.

One component of the AUI is a dynamic keyboard. Another component of the AUI provides mouse functions. The dynamic keyboard is an example of a dynamic user interface containing a plurality of input areas (e.g., keys such as “soft” or “hard” keys) in an adaptive graphical arrangement. For convenience of description, the input areas may be described hereinafter as “keys”. However, it is to be understood that keys are an example of an input area on the dynamic keyboard. Similarly, for convenience of description, the dynamic user interface of the present disclosure may be described hereinafter as a “dynamic keyboard”. However, it is to be understood that the dynamic keyboard is an example of a dynamic user interface.

In accordance with exemplary embodiments of the present disclosure, the AUI may be implemented as an apparatus including at least one display device, and at least one processing unit. The processing unit is configured to cause the at least one display device to display the dynamic keyboard containing a plurality of keys in an adaptive graphical arrangement, detect user inputs on the dynamic keyboard, and record the user inputs in a memory unit in association with a context of information inputted by the user. The processing unit can include one or more processors configured to carry out the operative functions described herein. The one or more processors may be general processors (such as those manufactured by Intel or AMD, for example) or an application-specific processor. The memory unit includes at least one non-transitory computer-readable recording medium (e.g., a non-volatile memory such as a hard drive, ROM, flash memory, etc.) that also records one or more executable programs for execution by the one or more processors of the processing unit. Unless otherwise noted below, the operative features of the present disclosure are implemented by the processing unit in conjunction with the display device and memory unit.

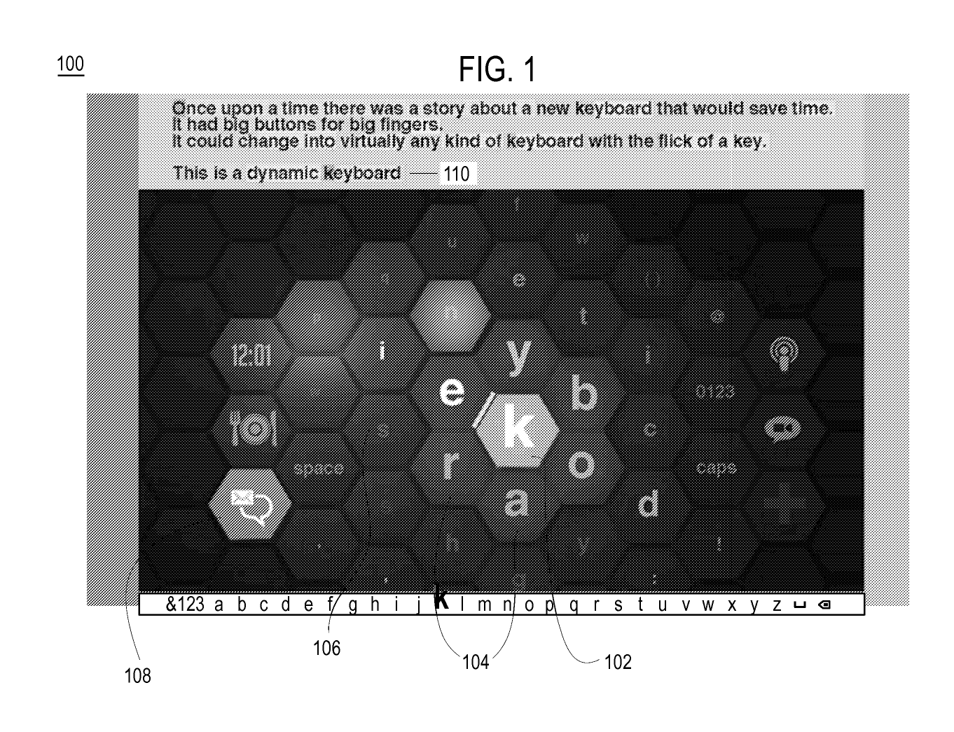

The dynamic keyboard functions as the central input device for many systems or subsystems. An example of the dynamic keyboard 100 is illustrated in FIG. 1. In the example of FIG. 1, the layout of the dynamic keyboard is a center hexagon (e.g., a primary key) 102, surrounded by 3 rings (e.g., layers) of hexagons that constitute secondary keys 104, tertiary keys 104 and so on. In the illustrated example, that amounts to a total of 37 soft “keys”, which is sufficient to show all the letters of the English alphabet plus 11 other symbols 108. It is conceived that the design of the dynamic keyboard can be modified to accommodate languages with fewer or more letters in their alphabet. It is to be understood that the configuration of the dynamic keyboard in the shape of a hexagon is exemplary, and the present disclosure is not limited thereto. The dynamic keyboard can be configured in other configurations or shapes. Furthermore, the input areas (e.g., “keys”) may be “hard” or “soft”. In either case, the value and location of an input area such as a key can change automatically or on command as the user uses the AUI.

Information on the keys moves toward or away from the center key based on the predicted likelihood of it being selected as the next key. In the illustrated example of FIG. 1, the word “dynamic” has already been typed. Based on the context and user's style (e.g., prior selections), the next letter, as a user input, is projected (e.g., predicted) to be a “k”. If the user selects the “k” key, the keyboard would project the word “keyboard” in a prediction field 110 which the user can accept or reject.

Accordingly, the processing unit of the AIA is configured to detect a user input for one of the input keys, compare the detected user input with prior user inputs recorded in the memory unit, and predict a first next user input (e.g., the letter “k”) based on the comparison and the context of information associated with the detected user input. The processing unit is also configured to, based on the predicted first next user input, dynamically modify the displayed arrangement of the input keys so that information associated with the predicted first next user input (e.g., the letter “k”) is characterized and displayed as at least one primary input area 102 on the dynamic keyboard. When the processing unit predicts the first next user input based on the comparison and the context of information associated with the detected user input, the processing unit is configured to predict a respective likelihood of other information being selected in a second next user input based on the context of information associated with the first next user input. In addition, the processing unit is configured display the other information associated with the context of information associated with the predicted first next user input in logical association with the primary key based on the respective likelihood of the other information being selected in the second next user input. In accordance with an exemplary embodiment, the primary input area 102 is arranged in logical association with at least one secondary input area 104, which may be arranged in logical association with at least one tertiary input area 106. The processing unit is configured display the other information associated with the context of information associated with the predicted first next user input in the secondary input area 104 based on the respective likelihood of the other information being selected in the second next user input.

Furthermore, the AUI can compare a detected user input to the dynamic keyboard with predicted inputs, and determine whether the user selected an incorrect key based on the predicted input. If it is determined that the user may have selected an incorrect key based on the predicted input, a proposed correction can be output in the prediction field for the user to accept or reject.

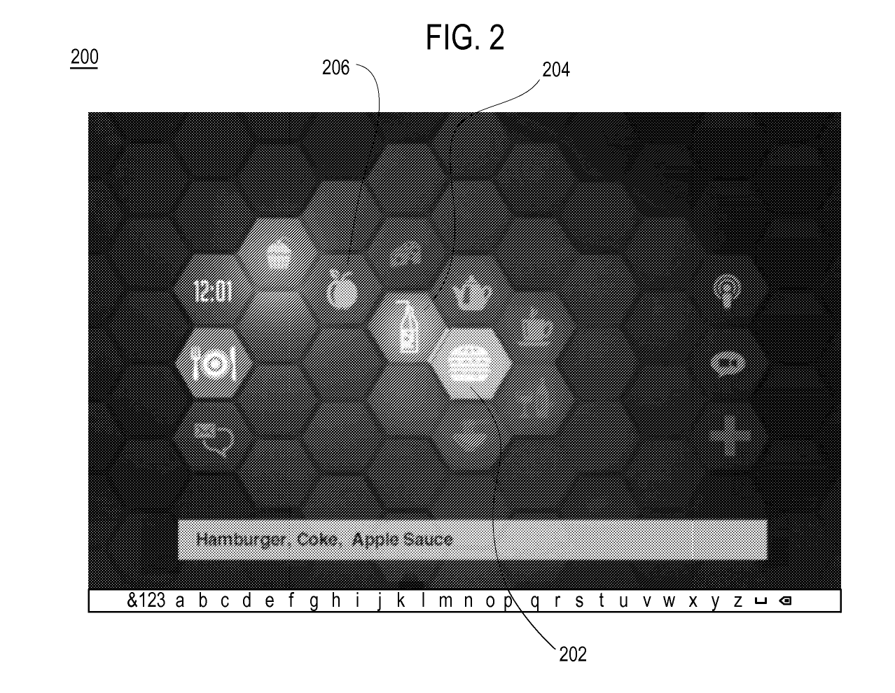

The keyboard has multiple dimensions or layers, all of which have predictive and dynamic characteristics when appropriate. For example:
Alphabet keys: For “typing” a message (predicts next letter, words and phrases learned from the user).
Sentence inventory: Stores often used phrases, sentences and paragraphs for easy retrieval.
Forms: For various types of written communications such as business letters, personal letters, communication with caregivers, etc. Here, the user completes a form that defines who the communication is direct to, the subject, key words and other relevant data. The system converts the Forms data to full paragraphs which the user can edit. The purpose here is to reduce the amount of detail while increasing the communications content.
Numbers and Symbols: The numbers and symbols layer will simplify input. For example, if the user wants to enter the number 24,000 they would need to activate the 2, 4, and, 000 key. Often used numbers will be stored and identified with a single click.
Icons: Icons for food, wheelchair, bathroom, temperature, humidity, TV, radio, music, games, etc., can be activated singularly or in combination with other Icons, to indicate a message. In FIG. 2, an example of a dynamic keyboard 200 is shown in which icons for food and a wheelchair are illuminated (e.g., activated). The AUI system asks the user for confirmation that the user wants the wheelchair to take him/her to the kitchen. For instance, as shown in the example of FIG. 2, the user selected a hamburger in the primary input area 202, and then based on that selection, a soft drink (e.g., Coke) appears next to the hamburger as the predicted beverage in a secondary input area 204. Based on this prediction, an apple icon is also displayed in a tertiary input area 206 based on a prediction that the user may want to also have an apple due to his or her selection of a hamburger and soft drink.
Telephone & email directories: Selecting the A key will produce a dropdown list of all contacts whose name begins with an A the B key for names beginning with B, etc. The user selects the “call” or “email” for the selected person and all the appropriate information is provided to complete the task.
Speech Conversion: In the case of a person who can hear but not speak, the typed message is converted to speech. User response can be “typed” or stored phrases/sentences can be selected, verified and then spoken by the text-to-speech system.

In the example of the dynamic keyboard described above with respect to FIG. 1, the information which is predicted to be the next user's input (e.g., the letter “k”) is moved to the central area of the dynamic keyboard as a primary input area of the dynamic keyboard, and other information which is predicted to be a subsequent user input based on the predicted next user input is moved in proximity to the primary input area. However, the present disclosure is not limited to this example. For instance, other techniques of characterizing the primary input area can include changing the attributes of one or more keys corresponding to the information which is predicted to be selected next by the user, causing the key corresponding to the information which is predicted to be selected next by the user to change color and/or flash or change the size of the keys, number the keys in order based on a predictive likelihood that the information corresponding to those keys will be selected next by the user, adding priority numbers to keys based on such a predictive likelihood, etc. These examples are not meant to be exhaustive. The AUI system can cause the dynamic keyboard to characterize the predicted next key or keys to be characterized in any manner so as to highlight the predicted next key or keys. As used herein, the terms “change” or “dynamic” mean any change to location, size, color, blink, turn on or off, change value, etc., by command or as an automatic response to user input.

The AUI may include a tactile sensing unit configured to receive tactile sensing inputs which may be audible, visual and/or touch inputs. The tactile input unit can receive inputs from the user via resistive sensing, capacitive sensing and/or optical sensing, for example.

The AUI can be integrated in a mobility assistance device such as a wheelchair, walker, cane, automobile, aerial or nautical vehicle, and personal transport vehicle. The AUI integrated in such a mobility assistance device can be configured as an input/output for the mobility assistance device.

For example, the present disclosure also provides for “SmartCanes” (including “SmartWalkers”). Visually impaired people use a cane to tap on the ground to output a tactile input that is recognized by a tactile input unit of the AUI. The tactile reception unit of the AUI can receive audible, visual and/or touch inputs. The return sound from tapping tells the user if there are obstacles ahead of them. SmartCanes will significantly improve that function by increasing the distance, accuracy and interpretation of the area. Light, radio and/or ultrasound signals from the cane could be used instead of the tapping. The Dynamic Keyboard may be built into SmartCanes as an input and/or output device. For example, a variable tone from the SmartCane could tell the user that all is clear or there is an obstacle in the path and approximately how far it is. A SmartCane could sense other people around the user and their activity. At a stop and go light movement of others will enhance the user's awareness.

SmartCanes could also help users navigate to their destination. Once the destination location is input into the SmartCane, the user could be prompted for directions to his or her destination and then guide the user along the way. Alternatively, once the destination location is input (or selected from stored or suggested destinations), the AUI system could retrieve and display, announce and/or provide tactical directions for the user. Smart Canes can provide the time of day, week, month, remind the user when to take medicine, make a phone call, etc. A smart phone could interface with the Dynamic Keyboard and the SmartCane to provide many other applications, support shopping activities, monitor health, and so on.

Many of the features listed above will also be applicable to Smart Personal Transport vehicles (such as Segway, Golf carts, etc.).

In addition, the present disclosure provides for the use of the keyboard in personal transport vehicles such as wheelchairs. In the illustrated example of FIG. 1, the user could select the icon representing a plate and silverware, at which point the user's wheelchair could navigate the user to the kitchen. For navigation functions relating to a user's designation of a particular key or selection on the Dynamic Keyboard, the transport vehicle could utilize the principle of recursive Bayesian estimation, as described in the attachment labeled “Recursive Bayesian Estimation”.

For example, the control of the direction and speed of an autonomous wheelchair inside a building may be controlled by a Bayesian filter algorithm because of the fixed structure that is defined in an interior space, e.g., the walls and doorways of a room, the placement of furniture, etc.

Moreover, eye-tracking could be utilized in which navigation occurs through what a user looks at through glasses (e.g., Google Glasses) or remote cameras. Such eye tracking features could replace other means of interfacing into the AUI system. Bayesian estimations can be made with regards to eye space navigation XYZ in combination with other inputs such as voice, touch, mind thoughts, etc.

In addition, the present disclosure provides for the implementation of a pan and tilt video camera or a 360 degree camera. Eye-tracking works by first calibrating the eyes and screen by using fiducial points that appear on the screen. Once calibrated, the eye tracking system can determine where the user is looking. From that information, the system can determine what the user is looking at. Some eye-tracking systems use special glasses, while other eye-tracking systems use remote cameras to detect where the eye gaze is directed. The AUI may contain a video input unit configured to receive such eye-tracking inputs.

Furthermore, the AUI of the present disclosure provides for the recognition of user inputs based on different types of enunciations of particular words, via an audio input unit of the AUI. For example, if a user enunciates the word “left” for a period of time (e.g., 3 seconds), to phonetically resemble “llllleeeeffffttt”, the dynamic keyboard could interpret that phonetic pronunciation as a command. In this example, the AUI system would move the cursor to the left or scroll the selectable keys or icons on the dynamic keyboard to the left for the duration of enunciation. The AUI system can also recognize other audible inputs such as whistling, or changes in breathing patterns, for example.

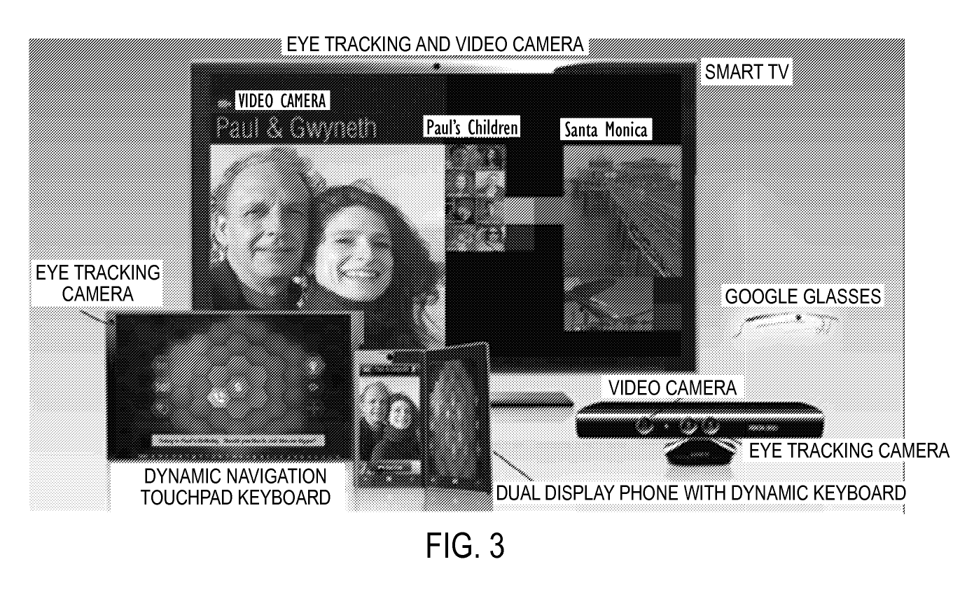

FIG. 3 illustrates an example of the AUI in which events, relationships, people, dates and other information can be remembered, organized and displayed to the user to support quick communication access. In the example of FIG. 3, the user is reminded that the current date is Paul's birthday, and the user is prompted whether he or she would like to make a call to Paul on his birthday. A picture of Paul is displayed in association with other information about Paul, including, for example, smaller pictures of Paul's children and information about where Paul and/or his children live. In the example of FIG. 3, a dual screen is displayed, where the above-described pictures are shown on one of the screens, while the dynamic keyboard is shown on the other screen. Using a dual screen, the dynamic user interface can provide simple icons for the user to navigate to the make a birthday call, for example. All related information is near the primary subject (e.g., the children, spouse, location, etc. of the primary subject), and each of these types of information can be keys enabling further exploration by the user. The self-organizing feature remembers and reminds the user to call. Touch, eye-tracking, gestures, voice control, etc. can be used to navigate the information source providing a more relevant and easy navigable experience.

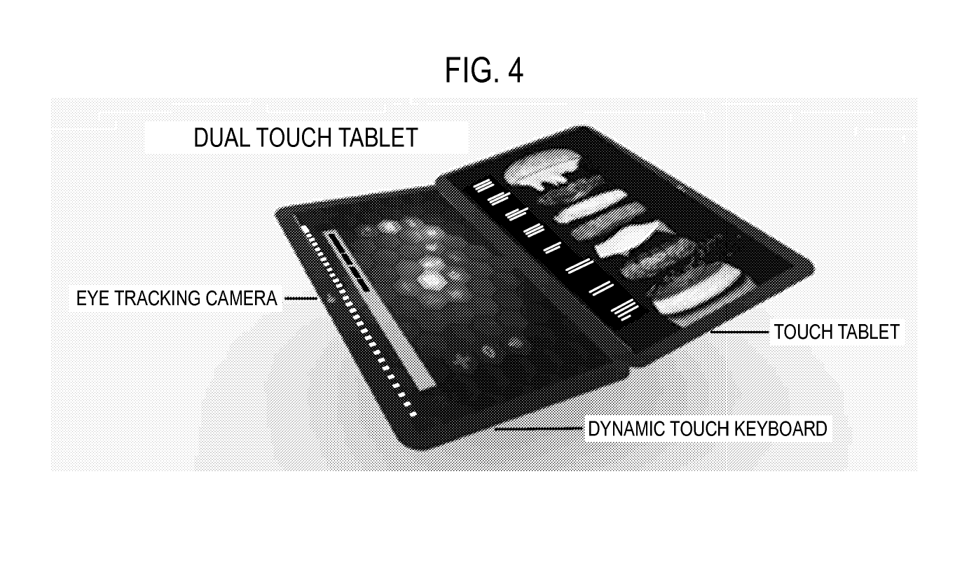

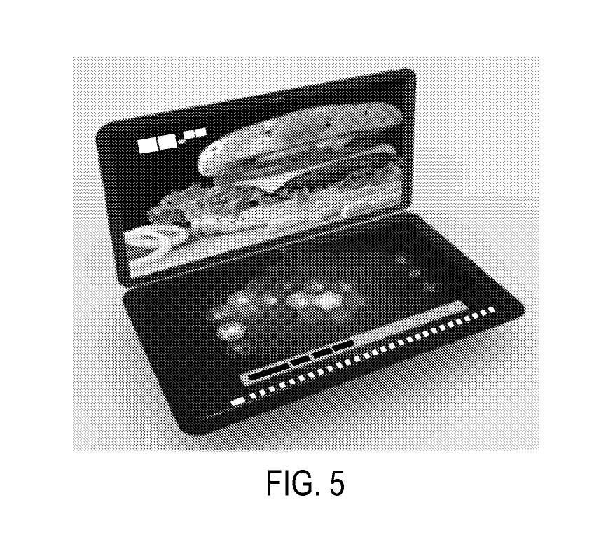

As noted above, the present disclosure provides for the dynamic keyboard to be displayed on one screen, while relevant information can be displayed on another screen of a dual-screen device, such as a personal computer, notebook tablet, smart phone, etc. FIG. 4 illustrates an example of a dual-screen touch tablet in which the dynamic keyboard is displayed on one screen of the tablet, and information about the user-selected icon is displayed on the other screen of the tablet. FIG. 5 illustrates an example of a dual-screen notebook in which the dynamic keyboard is displayed on one screen of the notebook and information about the user-selected icon is displayed on the other screen of the notebook. Another example of a dual-screen device is shown in FIG. 3, which illustrates a dual-screen smartphone having the dynamic keyboard displayed on one screen and information about the user-selected icon displayed on the other screen of the smartphone.

The present disclosure is not limited to dual-screen devices. For example, in devices such as a notebook computer, smart telephone, tablet computer and desktop computer, for example, a single screen can be split so that the dynamic keyboard is displayed one part of the screen, and relevant information can be displayed on another part of the screen. Another envisioned approach would be to enable the user to toggle between dynamic keyboard and the associated content. In addition, the dynamic keyboard could be configured as a wired or wireless keyboard to be accommodated in a computing device as an external input to that computing device.

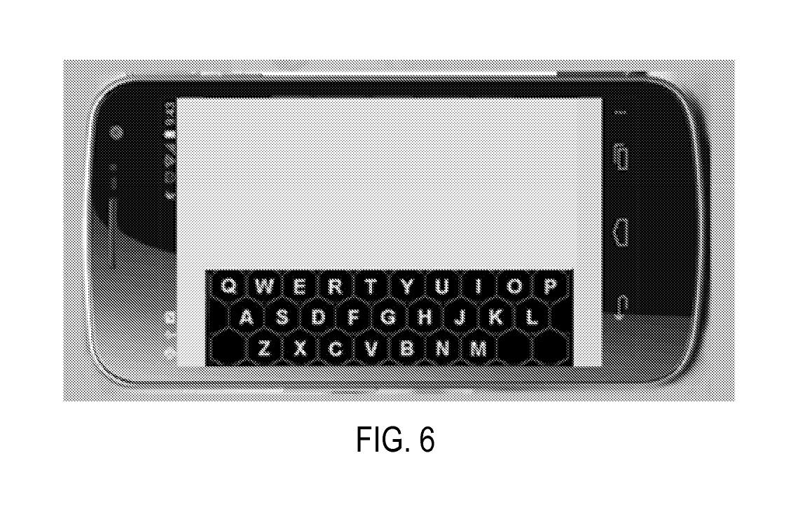

The input areas or keys can occupy any part of the screen of the display device(s). The user can select what part of the screen is occupied by the keys and what part of the screen is occupied by the user's input. For example, on a mobile device such as a cell phone, the keys might occupy 90% of the screen when the user is inputting information, leaving only 10% of the screen to see the result of the input. A toggle key can then be used to switch to a 20/80% ratio with the keys occupying 20% of the screen and the output occupying 80% of the screen, as shown in the example of FIG. 6. This is meant as an example, and any desirable ratio can be selected by the user so that the user can use part of the screen for input keys and toggle to display the output on a greater percentage of the screen when that is beneficial. Similarly, on a tablet or other computer device with a larger screen, the AUI provide the user with the ability to determine which part of the screen will be allocated to keys and which part will be allocated to output. The ratios of user input to output may also change depending on the particular operation being performed by the user.

In view of the above, the AUI dynamically responds to user inputs by simplifying the sourcing and displaying of related information. The dynamic user interface of the AUI uses an adaptive graphical arrangement of information. It is based on a self-organizing intelligent feedback system that supports a minimum information input for maximum information output through linked attributes. The predictive delivery of information is based on the context and the user interaction.

AUI users can range from fully functioning people of all ages to those who are limited by degenerative disease, birth defects and trauma. For all users, minimizing input is an advantage of the AUI system. Therefore, the AUI can implement multiple different techniques to minimize data entry. For example, when the user has a repeatable activity, the user can easily activate an icon that will record the activity, store it in a non-transitory computer-readable recording medium (e.g., a non-volatile memory) that is either local to the computing device executing the AUI functionality, or at a remote location, and create an icon that will require only a single action to enter the data in the future (e.g., often used abbreviations, paragraphs, commands, salutations, signature lines, etc.). As the user selects letters to form words and words to form sentences and paragraphs, the word processing function of the AUI can suggest spelling and grammatical corrections. The user can then accept the suggestions or reject them. In addition, the user can define icons such as “wp” for an entire “warranty paragraph” that can be invoked by activating the “wp” icon, or a “mail” icon for “don't forget to pick up the mail”, and the AUI will recognize the icon activation and execute an appropriate operation based on the user-created icon. As such, a small amount of information inputted by the user can result in a large amount of information and/or processing.

The AUI can also create new icons based on user selections of a group of icons. For example, if the user selects icons such as “Wheelchair” plus “Kitchen” plus “Enter” for an action of “Take me to the kitchen”, an automated compression system of the AUI can create a single icon for this command, so that the user can later select this command instead of the aforementioned group of icons. Activation of this newly created icon will then move the user's wheelchair to the kitchen.

The AUI enables key creation and key downloading (e.g., from an AUI or other external website). This feature allows the AUI to remotely or locally create and download permanent or temporary dynamic keyboard keys which are selected or allowed by the user. In addition, special offer keys can provide a source of advertising revenue. For example, advertisers could remotely create dynamic keyboard keys which, when activated, would display coupons, special offers, videos, websites, etc. These special offer keys could require an opt-in feature and could have automatic expiration dates.

In addition, the AUI could be configured with a local “create a key” option, in which the user can select to create a new key as indicated above. Furthermore, dynamic keyboard keys could be created by other means, such as by scanning a barcode, or downloading them from an AUI website or other website. Keys can also be created by merging multiple keys, for example. Keys can be used to access product information, instructions, purchase information, etc., as well as order subscription services (e.g., “I want to subscribe to the Wall Street Journal”, or “I want to read today's Wall Street Journal”). Game keys can also be used and/or created to select and activate on-screen games.

The AUI can also provide an autonomous wheel chair to be controlled by the dynamic keyboard. In connection with the autonomous wheel chair, recognizable markers such as RFI tags can be provided at the corners of rooms or furniture to enable navigation within that area. The autonomous wheel chair may include an optical scanning component to recognize features such as walls as well as markers such as RFI tags, barcodes, etc. at various locations within a building.

The AUI can provide unlimited dimensions of multiple layer keyboard/mouse configurations. In addition, keyboard parts can be concatenated to form a new arrangement, and there can be automatic keyboard/mouse configuration.

With respect to mouse movement, the mouse characteristics can be customized in keeping with the activity of the user. For example, when executing a word processing function, the ideal size, shape, speed and resolution of the mouse differs from the ideal settings for a draftsman working on CAD tools. The mouse characteristics can be programmed to change with the user's function.

The mouse cursor can be automatically positioned to a predetermined location such as the last location used for this document.

There can also be a mouse movement substitute. For example, when there is a single choice, the key or icon changes character (size, color, etc). Activating the Enter key selects the identified choice. When there is more than one choice, the characteristics of all probable choices change and are automatically numbered. The user selects the alternative by activating the choice number.

In an exemplary embodiment of the AUI, information interchange is facilitated between different executable programs. For example, when the user is working on multiple programs, such as MS Word, Excel and PowerPoint, or multiple versions of one or more programs, information from one program can be automatically transferred to the other program(s).

There are multiple ways to accomplish this action. Here is one example procedure:

a. Enter the data that is to be shared into one of the programs
b. Highlight the information to be used in more than one program
c. Activate the Shared Information Icon
d. Identify the location in each program where the shared information is to be placed
e. The system will automatically enter the data into the proper place using the local formatting.

The sequence identified above can be rearranged. For example, the location of the data in each program can be selected before the sharable data is entered.

A special set of icons will be available for a user to express feelings, make requests or receive instructions. Using these keys, the user can also alert remote care givers or others. For example, a user can indicate he/she is warm, cold, hungry, needs to go to the bathroom, etc., by simply selecting and activating the appropriate icon. The message can be sent automatically to one or more people that are supporting the user. As another example, users can receive automated instructions and reminders such as “It is time to take your afternoon pills”, or a remote party can send a reminder which will be activated at the designated time.

When a user selects a key (command, letter, word, phrase, number, icon, etc.,) depending on the user's limitations, he/she can activate the key in numerable ways, including, for example:
Press one or more keys on a physical, screen based or projected keyboard
Make a gesture
Speak the letter or word or icon name
Dwell on the target key (the key can display the hands of a clock or other active symbol so the user knows how long to dwell)
Blink one eye or both eyes
Move their head
Stick out their tongue
Move their lips

The above-described examples of user-selections of keys can also cause feedback to be provided by the AUI system to the user to activation of the particular key or icon.

The AUI can include an attribute system based on heuristics, i.e., learn from experiences.

For example, if it is found that all records of Attributes A, B and C for a user in the database of the AUI also have Attribute D, the user can be asked to verify that all future records with Attributes A, B and C should have Attribute D. If the answer is yes, Attribute D can be added to any records with Attributes A, B and C. Alternatively, Attribute D can be added to all future records that have Attributes A, B and C without asking the user. If the answer is no, Attribute D is not added, but this can be rechecked to determine if the relationship continues to be true.

If it is found that all records that have Attributes A B and C also have either or both Attributes E or F, etc., it can then be determined which other Attributes are present or not present when the decision is made regarding the selection or E, F or none of the above. At that point, the decision can be automated.

When the attribute matching algorithm gets beyond an acceptable level of complexity, the AUI can stop searching for matches at the time of entry and use a batch search procedure or possibly the Real-time Data Warehouse to search the records for all such rules. The system could then prepare a report showing all cases where a match is useful.

For example, if Attribute A is a Customer's name (Jones & Co) and Attribute B is a customer's address (123 Smith Street, Seattle) and Attribute C is the Region (North West), any account(s) that have Attributes A and C are likely to be related (a store, office, warehouse, etc., of A). We are probably not looking at an unrelated company with the same name in the same Region (NW). It has been observed that there is a high likelihood that Customer A has more than one facility in the NW Region and can link them automatically. A report for the user can then be prepared to approve all additional Attributes that are logically inferred.

In the example above, the entire Customers' relationship with its stores, warehouses, etc., may be entered on the Customer screen or the subsidiaries' screen. However, when a new store or warehouse opens, users may forget to do that. This heuristic approach will minimize such errors and reduce the amount of data input, speeding the entry process and reducing errors.

As another example, it can be deduced that the father of a child is the grandfather of his child's child. If we run across a situation where a child has more than 2 parents or 4 grandparents a flag is raised so that the relationship can be explained (one parent died, the other remarried and is now the step-father, etc.) It is also useful for predicting something the user may want to convey in a communication, Dear Uncle Bill.

The heuristic processing of the AUI can be triggered by an action of the user or in some cases by the launch of a program or process, so as to avoid slowing down the system processing.

The heuristic process would require sets of rules, which will be updated frequently. When comparisons are made, the files related to the comparisons are locked. That causes a slowdown in the processing. Therefore, it is good practice to keep the number and duration of locked files to a minimum. This is especially important for multi-user systems.

The AUI can apply corrective processing when a user is trying to connect one Attribute with another, a correct linking has “attractive” properties (a+Attribute) and a wrong linking has “rejection” properties (a−Attribute). For example, if a user tries to link the name Bob with a photo of Bob, the link works, however, if a user tries to link a photo of Bob with the name Bill, the link is rejected.

The following are examples of how heuristic attributes can be utilized in the AUI.

MY LIFE is an expanded family tree concept. Typically, family trees are built on a tree structure not unlike accounting systems, which are also built on tree structures. Using the Attribute system, MY LIFE can be organized many ways, including a tree structure, although the present disclosure is not limited thereto. For example, attributes can be used to organize an entire ERP system, which integrates all business functions.

Based on the attribute system of the AUI, MY LIFE could support describing people, places and things and their relationships in many ways, each characteristic is an Attribute. For example, a person can be identified by a picture, the person's name, address, contact information, fingerprint, etc., are ways to describe/identify him/her. A man can be: a husband, father, grandfather, brother, child, cousin, etc. He can also be a friend, boss, neighbor, club member, etc. Likewise, a woman can be described in many ways. A person can also be an equestrian, race car driver, employee, employer, and so on. In addition, a person can own a car, house, and airplane, etc., etc. Many of the Attributes will be shared by multiple people, places or things. For example, more than one person will be named Alex. So there are literally hundreds of ways to describe people in the user's life.

Activities, including a variety of games, can be designed to link Attributes to the proper person. Of course, many people will be described as a husband and father but probably only one person will be described as a man named Bob married to a woman named Carol with children named Debbie and David and Bob's parents are named Samuel and Revel and Carol's parents are named Herman and Belle.

The use of Attributes in this way can also be used to deduce that Debbie and David are the grandchildren of Samuel, Revel, Herman and Belle and that Debbie's and David's children are the grandchildren of Bob and Carol and so on.

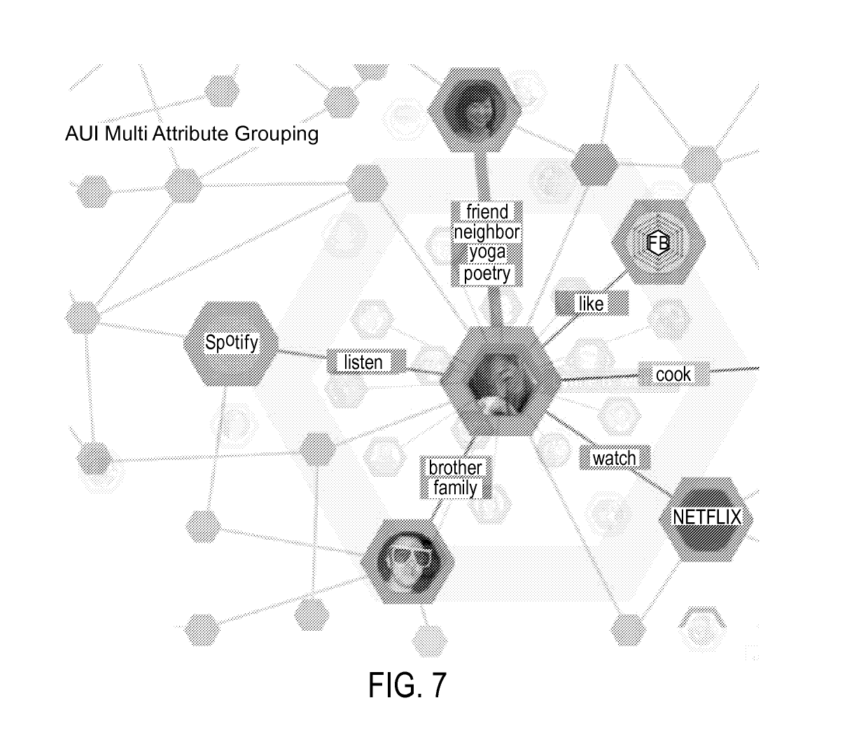

One objective of MY LIFE is to be self-organizing. Since social networks and ancestry services have already linked many millions of people, much of the matching can be imported from existing “trees”, as shown in the example of FIG. 7, which illustrate associations between individuals or groups and their activities and networks. Keywords relating to common interests, activities or any other associations can be used to link individuals or groups to each other.

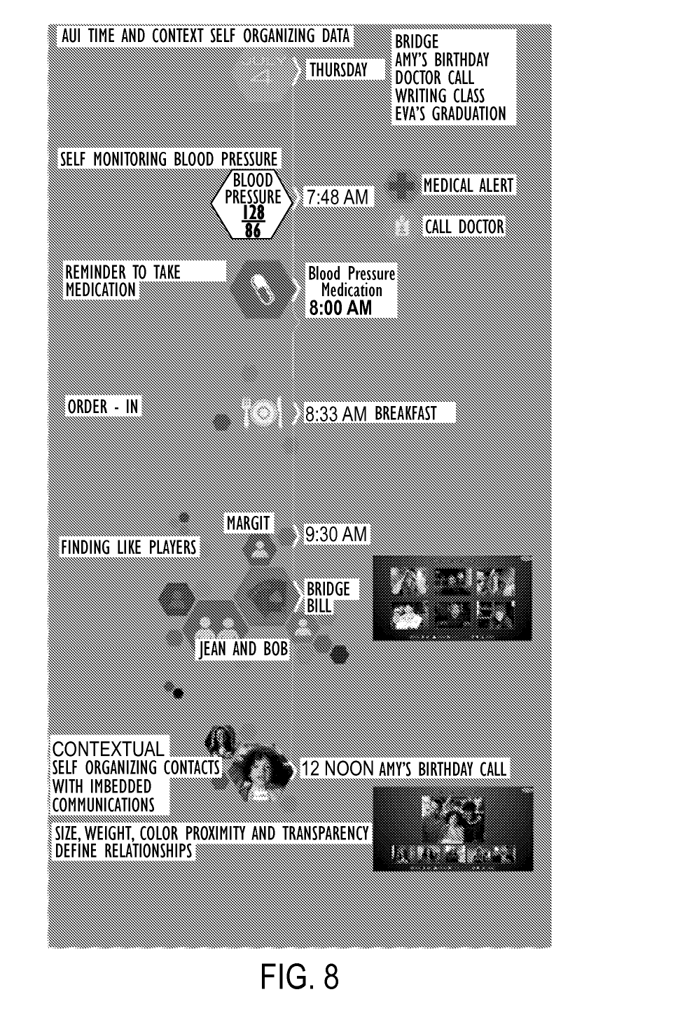

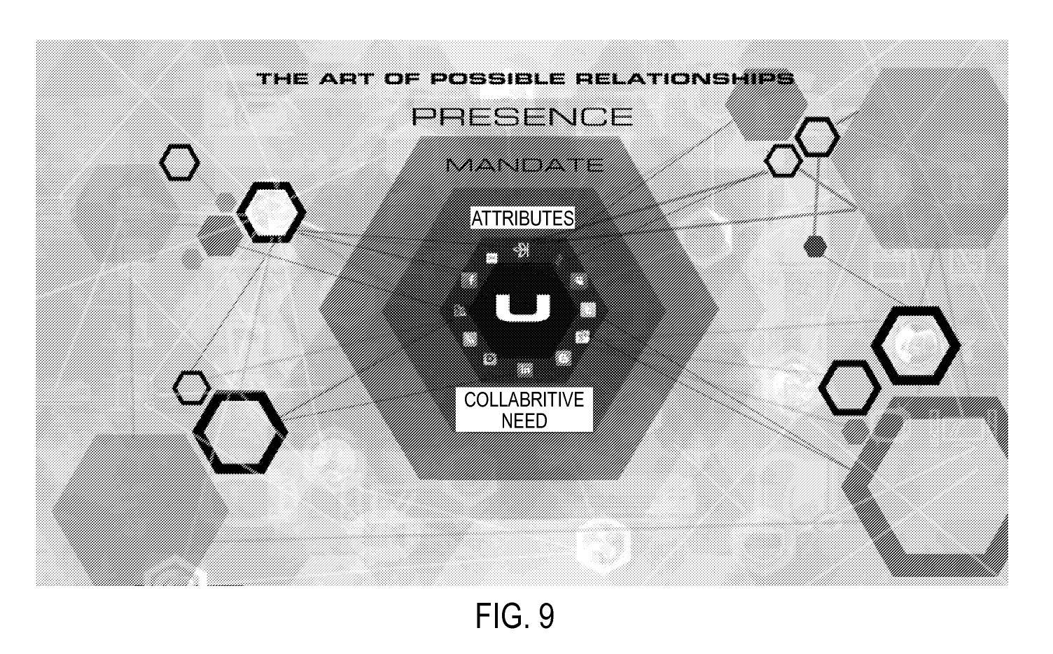

Attributes, Attribute Groups, Attribute Centers and Virtual Attribute Groups will be used to describe people, places, things and their relationships. In addition, Attributes and Attribute Groups can be used to describe locations (map points), characteristics (color, size, etc.) time or timing (duration, time to take pills, etc.), value (monetary or other), command (turn up the heat) and or any other data or metadata that describes or identifies any real or imaginary thing or action. FIG. 8 illustrates an example of a daily schedule for an individual which identifies, in an customizable format, areas of interest associated with particular people, tasks, activities, attributes, time and context information, etc. FIG. 9 illustrates another example of attribute grouping based on an individual or group's interests such as social networking activities and any other type of association.

For example, one feature of the AUI is to provide wheelchair users with autonomous wheelchairs that respond to touch, verbal, eye command or other command format to a command such as, “Take me to the Kitchen.” To do that, the autonomous wheelchair must have a map of the house, including directions to go from any place in the house to any other place in the house. Attributes and Attribute Groups can be used to identify each waypoint.

Since any Attribute or Attribute Groups can be linked to any other Attribute or Attribute group, if lunch is scheduled at 12:00 Noon. At Noon, an announcement can be made by the system to a patient that it is time for lunch; the autonomous wheelchair can be launched automatically to the location of the patient; and the patient is taken to the dining room.

As noted above, the AUI is dynamic and heuristic. It recognizes user's habits, processes and procedures and signals the user when a process or procedure appears to be one that will be used in the future. The user can confirm or deny future use. If the process or procedure is to be saved, it is given a set of Attributes, which include the party's name, email address, information about the party and other information useful to the user. An icon is made automatically and all is saved for another use. If no use is made after a predetermined period of time, the process or procedure is archived and eventually discarded.

An example of such an activity would be sending email to a person not currently on the email list. If it is likely that the user will send additional emails to the party, the name, email address, reason for communication and other useful information is set up in the email file. The next time an email is received from the party or an email is initiated by the user to the party, all the procedures for the communication are already in place.

Another example of how Attributes and Attribute Groups will be used to facilitate communication is that users can assign an abbreviation to an Attribute. The abbreviation can stand for a saved sentence, a paragraph or more. Thus cutting down on the amount of input required for the communication.

The AUI Database will be designed so that any Attribute or Attribute Group can be linked with any other Attribute or Attribute Group and assembled into an Attribute Center or Virtual Attribute Center.

In addition, Attributes and Attribute Groups can be utilized in the AUI as adaptive triggers for the dynamic keyboard. For example, when a particular person becomes available, such as a secretary for example, a hotkey or icon may be prominently displayed on the display screen of the AUI. The color of the icon may change based on whether the person is engaged in some other activity. The availability or presence for such triggering events is not limited to humans. For example, robotic entities, ROVs, androids, etc. entering a defined physical or logical zone of presence could also trigger the display of such an icon. In addition, the combination of humans and robots could be the basis for a triggering event. The triggered icon can be turned on or off. The service status of a device or system such as machinery may be the triggering event. Low oil, high pressure, off line, etc. are examples of service status triggering events.

As mentioned above, the present disclosure includes FIGS. 1-5. In addition, the present disclosure includes a presentation entitled “Advanced User Interface, LLC” (totaling 23 pages).

The embodiments of the present disclosure can be utilized in conjunction with the following four patent documents:
1. U.S. Pat. No. 7,711,002
2. U.S. Pat. No. 7,844,055
3. U.S. Pat. No. 7,822,654

What is claimed is:

1. An apparatus comprising:
at least one display device;
a processing unit configured to cause the at least one display device to display a dynamic user interface containing a plurality of input areas in an adaptive graphical arrangement, detect user inputs on the dynamic user interface, and record the user inputs in a memory unit in association with a context of information inputted by the user, wherein:
the graphical arrangement of input areas includes at least one primary input area, each of the input areas being respectively associated with different information;
the processing unit is configured to compare a detected user input for one of the input areas with prior user inputs recorded in the memory unit, and predict a first next user input based on the comparison and the context of information associated with the detected user input; and
the processing unit is configured to, based on the predicted first next user input, dynamically modify the displayed arrangement of the input areas so that information associated with the predicted first next user input is characterized and displayed as the at least one primary input area on the dynamic user interface.

2. The apparatus of claim 1, wherein:
the processing unit is configured to, in predicting the first next user input based on the comparison and the context of information associated with the detected user input, predict a respective likelihood of other information being selected in a second next user input based on the context of information associated with the first next user input; and
the processing unit is configured to display the other information associated with the context of information associated with the predicted first next user input in logical association with the primary input area based on the respective likelihood of the other information being selected in the second next user input.

3. The apparatus of claim 2, wherein:
the primary input area is arranged in logical association with at least one secondary input area; and
the processing unit is configured display the other information associated with the context of information associated with the predicted first next user input in the secondary input area based on the respective likelihood of the other information being selected in the second next user input.

4. The apparatus of claim 3, wherein:
the primary input area and the at least one secondary input area are each arranged as a geometric shape.

5. The apparatus of claim 1, comprising:
at least one tertiary input area arranged in logical association with the at least one secondary input area.

6. The apparatus of claim 1, wherein the input areas are associated with information including at least one of alphabet letters, numbers, symbols, phrases, sentences, paragraphs, forms, icons representing an executable operation, icons representing a commodity, icons representing a location, icons representing a form of communication, a command, and a mathematical notation.

7. The apparatus of claim 1, wherein:
the dynamic user interface includes a prediction field; and
the processing unit is configured to predict information associated with one or more user inputs and display the predicted information in the prediction field for the user to one of accept and reject the predicted information.

8. The apparatus of claim 7, wherein:
the processing unit is configured to compare a detected user input to the dynamic user interface with the predicted first next user input, and determine whether the user selected an incorrect input area based on the predicted first next user input; and
when the processing unit determines that the user selected an incorrect input area, the processing unit is configured to output a proposed correction in the prediction field for the user to one of accept and reject the proposed correction.

9. The apparatus of claim 1, wherein the apparatus is integrated in a mobility assistance device as an input/output unit for the mobility assistance device.

10. The apparatus of claim 9, wherein the mobility assistance device includes at least one of a personal transport vehicle, a walking assistance device, an automobile, an aerial vehicle, and a nautical vehicle.

11. The apparatus of claim 10, wherein the processing unit is configured to control the display device to display navigation information to a destination that is at least one of input and selected by the user by selecting at least one of the input areas of the dynamic user interface.

12. The apparatus of claim 1, wherein the apparatus is a computing device including at least one of a notebook computer, a tablet computer, a desktop computer, and a smartphone.

13. The apparatus of claim 12, wherein:
the computing device includes two display devices;
the processing unit is configured to display the dynamic user interface on one of the two display devices; and
the processing unit is configured to display information associated with at least one of the input areas selected by the user on the other one of the two display devices.

14. The apparatus of claim 1, wherein the processing unit is configured to control the display device to display the dynamic user interface on a first part of the display device, and display information associated with at least one of the input areas selected by the user on a second part of the display device such that the dynamic user interface and the information associated with the at least one of the input areas selected by the user are displayed together on the display device.

15. The apparatus of claim 1, comprising:
at least one of an audio input unit configured to receive an audible input from the user, a visual input unit configured to receive a visual input from the user, and a tactile unit configured to receive a touch input from the user,
wherein the processing unit is configured to interpret at least one of an audible input, a visual input, and a tactile input received from the user as a command to at least one of (i) select a particular input area on the dynamic user interface, (ii) scroll through input areas on the dynamic user interface, (iii) request information respectively associated with one or more user input areas on the dynamic user interface, and (iv) control movement of a mobility assistance device in which the apparatus is integrated.

16. The apparatus of claim 15, wherein:
the visual input unit is configured to obtain a facial image of at least one of the user and another individual; and
the processing unit is configured to associate personal information about the at least one of the user and the other individual from whom the facial image was obtained, and control the display unit to display the associated personal information.

17. The apparatus of claim 1, wherein the processing unit is configured to generate an icon for display on one of the input areas of the dynamic user interface based on a successive selection of a combination of input areas by the user.

18. The apparatus of claim 1, wherein the processing unit is configured to recognize repeated user inputs on the dynamic user interface based on the recorded user inputs in the memory unit, and generate an icon for display on one of the input areas of the dynamic user interface for an activity associated with the repeated user inputs.

19. The apparatus of claim 1, wherein the processing unit is configured to at least one of customize the dynamic user interface and a mouse associated with the dynamic user interface based on an activity of the user.

20. The apparatus of claim 1, wherein the processing unit is configured to transfer information associated with one or more user inputs between different applications executable on the apparatus.

21. The apparatus of claim 1, wherein the processing unit is configured to control the display device to prompt the user to perform an activity in association with information recorded in the memory unit with respect to at least one of a date, time and event.
